(19) United States
(12) Patent Application Publication
(10) Pub. No.: US 2017/0282042 A1
(43) Pub. Date: Oct. 5, 2017

(54) Golf Swing Practicing Apparatus and Practicing Methods

(71) Applicant: Ue-Ming Yang, Chicago, IL (US)

(72) Inventor: Ue-Ming Yang, Chicago, IL (US)

(21) Appl. No.: 15/623,019

(22) Filed: Jun. 14, 2017

Related U.S. Application Data
(63) Continuation-in-part of application No. 14/819,400, filed on Aug. 5, 2015.

(51) Int. Cl. A63B 69/36; G09B 19/00

(52) U.S. Cl. CPC A63B 69/3641; A63B 69/3667; A63B 69/3632; G09B 19/0038; A63B 2071/0694

(57) ABSTRACT

Present invention discloses a golf swing practicing apparatus for practicing golf swing in a confined environment with a short-shaft golf club, practicing methods for setting up the short-shaft golf club at a proper incline angle in mid air at address position, and a mechanic model for determining the required club head weight that enables golfer to feel the same Swing Weight as he swings the short-shaft golf club or the conventional golf club.

### BACKGROUND OF THE INVENTION

Present invention relates to a golf swing practicing apparatus for practicing golf swing in a confined environment with a short-shaft golf club and an aiming device. Practicing methods are developed by a series of graphical methods (FIG. 1-4) to teach golfer how to set up the short-shaft golf club at a proper incline angle in mid air at address position before initiating a golf swing, and thus enables golfer to practice golf swing in a proper swing plane corresponding to the incline angle of short-shaft driver club.

Developing fundamental golf skills requires constant practicing, which is normally taken place in golf course or driving range. However, author of present invention finds that most fundamental golfing skills can be conveniently obtained by practicing golf swing without striking a golf ball in a confined environment, such as at home or in office. These fundamental golf skills include: (1). how to rotate forearms and hinge hand wrist to properly open club face during takeaway, (2). how to position club shaft parallel to ground and parallel to target line with properly-opened club face during takeaway, (3). how to keep club face open to the swing plane after takeaway, and (4). how to develop consistent swing plane, path and temple.

Clearly, practicing golf swing in a confined environment requires a short-shaft golf club with a substantially reduced club length. By substantially shortening the club length, club head can be located much closer to the grip, so that golfer can easily see club face and verify if club face is properly opened during a golf swing. In this respect, it is advantageous for practicing golf swing with a short-shaft golf club.

We all know that, when a conventional (full-shaft length) golf club is used in a golf game, golfer sets up its incline angle at an address position by placing its club head immediately behind golf ball and adjacent to ground. Golfer can then initiate golf swing in a swing plane corresponding to the incline angle of golf club. By substantially shortening the club length, club head of short-shaft golf club is now suspended in mid air substantially above ground at address position. Under such condition, golfer can't possibly determine or set up the incline angle of short-shaft golf club at address position. Without the ability to determine or properly set up the incline angle of short-shaft driver club in mid air at address position, golfer is deemed to practice golf swing in an improper swing plane.

Author of present invention develops a series of graphical methods (FIG. 1-4) to analyze the geometrical relationship between the club lengths of short-shaft golf club and conventional full-shaft length golf club, and the locations of club heads, golfer's feet, hands and eyes. Based on these graphical methods (FIG. 1-4), author of present invention is able to develop the practicing methods that enable golfer to set up short-shaft golf club at a proper incline angle in mid air before initiating a golf swing, and thus enable golfer to practice golf swing in a proper swing plane corresponding to the incline angle of short-shaft golf club.

Author of present invention also develops a mechanic model and calculation method to determine the required head weight of the club head of short-shaft golf club, and thus enables golfer to feel the same Swing Weight as he swings short-shaft golf club or conventional golf club.

### SUMMARY OF PRESENT INVENTION

An objective of present invention is to provide a golf swing practicing apparatus for practicing golf swing in a confined environment with a short-shaft golf club.

Another objective of present invention is to provide practicing methods for setting up short-shaft golf club at a proper incline angle in mid air at address position, and practicing golf swing in a proper swing plane.

Another objective of present invention is to provide the club head of short-shaft golf club with a head weight that enables golfer to feel the same Swing Weight as he swings short-shaft golf club or conventional golf club.

### BRIEF DESCRIPTION OF THE DRAWINGS

FIG. 1 shows the short-shaft driver club and the aiming device that form the first preferred embodiment of golf swing practicing apparatus of present invention, and the graphical method for setting up short-shaft driver club at 45 degree incline angle in mid air.

FIG. 2 shows the first preferred embodiment of golf swing practicing apparatus of FIG. 1, and the graphical method for setting up short-shaft driver club at 40 degree incline angle in mid air.

FIG. 3 shows the short-shaft iron club and the aiming device that form the second preferred embodiment of golf swing practicing apparatus of present invention, and the graphical method for setting up short-shaft iron club at 55 degree incline angle in mid air.

FIG. 4 shows the second preferred embodiment of golf swing practicing apparatus of FIG. 3, and the graphical method for setting up short-shaft iron club at 50 degree incline angle in mid air.

### DETAILED DESCRIPTION OF THE DRAWINGS

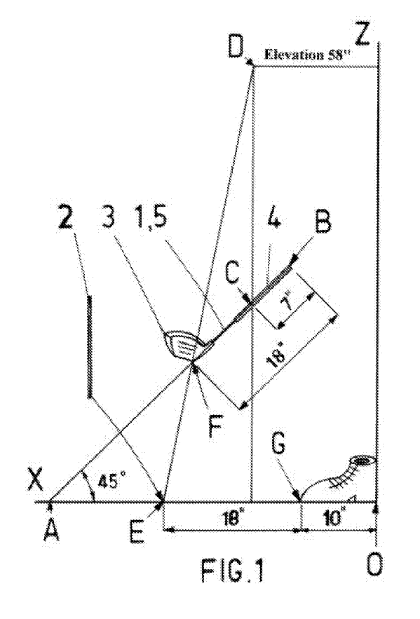

FIG. 1 shows a short-shaft driver club 1 and an aiming device 2 that form the first preferred embodiment of golf swing practicing apparatus of present invention. Aiming device 2 is constructed of an elongated object, such as the short stick shown in FIG. l. Short-shaft driver club 1 has a driver head 3, a grip 4, and a club shaft 5. Driver head 3 or grip 4 is in the form identical to that of driver head or grip of conventional driver club commonly used in a golf game. FIG. 1 represents a graphical method for setting up short-shaft driver club 1 at 45 degree incline angle in mid air. This 45 degree incline angle is based on the following input data adopted by graphical method of FIG. 1:

(1). Club length of conventional driver club commonly used in a golf game is 45″. (2). Ben Hogan has developed a theory that 1.5″ of grip's butt end of driver shaft shall be extended behind the heel of golfer's shoe when the driver is laid down on ground with club head aligned to golf ball. (3). Ben Hogan has illustrated that incline angle of driver shaft is about 45 degree at address position. (4). Ben Hogan has illustrated that an eye-to-thumb line is substantially vertical to ground. (5). Ben Hogan has an average golfer's height 5′8″, and his eye is located at about 58″ above ground as he stands at address position. (6). Front thumb of golfer's hands at grip is about 7″ away from the butt end of grip. (7). Average golfer's shoe size is 10″ from toe to heel.

The graphical method of FIG. 1 consists of the following steps: (a). plotting an X-Z coordinate in scale and in a inch dimension, in which, X axis represents a horizontal ground distance pointing perpendicularly away from the front body of golfer, Z-axis represents a vertical distance above ground, and zero base O (0, 0) represents the heel of golfer's shoe when golfer is at address position; (b). locating a point A (43.5, 0) on X-axis to represent the location of driver head of conventional full-shaft length driver club, in which, 45−1.5=43.5; (c). plotting an 45 degree sloped line AB to represent the conventional driver club at address position, in which, club length of conventional driver club is represented by AB=45; (d). locating a point C in line AB to represent the location of golfer's front thumb on grip 4, in which, BC=7; (e). plotting a vertical line passing through point C to represent an eye-to-thumb vertical line; (f). locating a point D in eye-to-thumb vertical line at elevation=58″ to represent the location of golfer's eyes; (g). locating a Point E (28, 0) on X-axis to represent the location of aiming device 2, in which, distance between the aiming device 2 and the toe G of golf's shoe is represented by EG=28−10=18; (h). plotting a line DE to represent an eye-to-aiming device line, in which, line DE intersects line AB at point F; (i). measuring the distance between point B (i.e. butt end of grip 4) and point F (i.e. heel end of driver head 3) that represents the club length of short-shaft driver club 1, in which, club length BF=18″; (j). drawing the configuration of driver head 3 at point F, in which, incline angle between club shaft 5 and the top line of driver head 3 is 120 degree, top width between toe and heel of driver head 3 is 5 inches, and height between top line and sole line of driver head 3 is 2 ½ inches.

It should be noted that, in steps (h)-(j), “eye-to-aiming device 2” line DE intersects short-shaft driver club 1 (i.e. line BF) at the heel end F of driver head 3. This means that golfer physically aims the heel end F of driver head 3 at aiming device 2.

It should also be noted that, in steps (g) and (i), EG=18″, and BF=18″. This yields EG=BF=18″. But the question is that, if point E is not selected at (28, 0) on X-axis in step (g), is EG always equal to BF? To answer this question, author of present invention repeats the step (g) of graphical method of FIG. 1 by locating point E at other locations on X-axis, and finds that EG (i.e. distance between aiming device 2 and the toe line of golfer's shoes) is always equal to BF (i.e. club length of short-shaft driver club 1). This important finding contributes a unique design feature of golf swing practicing apparatus of present invention, and helps author of present invention to develop the following practicing method for setting up short-shaft driver club 1 at 45 degree incline angle in mid air: (1). using short-shaft driver club 1 as a measuring stick to place and position aiming device 2 on ground at the club length of short-shaft driver club 1 ahead of and in parallel to the toe line of golfer's shoes; (2). positioning the front thumb of golfer's hands on grip in a substantially vertical eye-to-thumb line; and (3). aiming the heel end of driver head at aiming device 2.

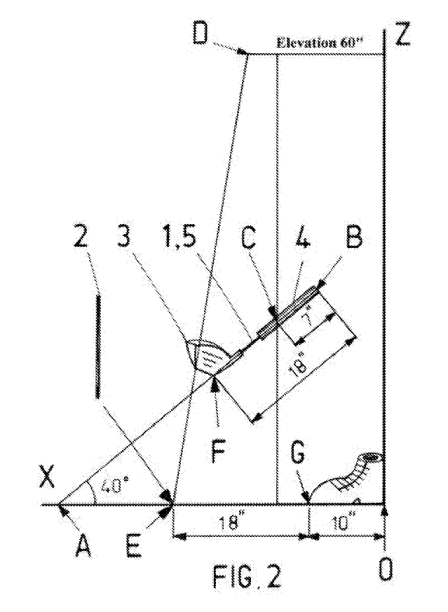

FIG. 2 shows the same short-shaft driver club 1 and aiming device 2 of FIG. 1, and the graphical method for setting up short-shaft driver club 1 at 40 degree incline angle in mid air. Graphical method of FIG. 2 adopts the same input data of graphical method of FIG. 1 with the following exceptions:

(1). Many modern professional golfers including Tiger Wood have illustrated that incline angle of driver shaft is about 40 degree (in lieu of 45 degree) at address position. (2). Tiger Wood has illustrated that a chin-to-thumb line (in lieu of eye-to-thumb line) is substantially vertical to ground. (3). Wood's eye location is at about 60″ above ground, and 4″ extended forwardly from his chin at address position.

Graphical method of FIG. 2 consists of the following steps: (a). plotting an X-Z coordinate in scale and in a inch dimension, in which, X axis represents a horizontal ground distance pointing perpendicularly away from the front body of golfer, Z-axis represents a vertical distance above ground, and zero base O (0, 0) represents the heel of golfer's shoe when golfer is at address position; (b). locating a point A (43.5, 0) on X-axis to represent the location of driver head of conventional full-shaft length driver club, in which, 45−1.5=43.5; (c). plotting an 40 degree sloped line AB to represent the conventional driver club at address position, in which, club length AB=45; (d). locating a point C in line AB to represent the front thumb location on grip 4, in which, BC=7; (e). plotting a vertical line passing through point C to represent a chin-to-thumb vertical line; (f). locating a high point in the chin-to-thumb vertical line at elevation=60″, and shifting this high point horizontally and forwardly by 4 inch to locate point D, which represents the location of golfer's eyes; (g). locating a Point E (28, 0) on X-axis to represent aiming device 2, in which, distance between the aiming device 2 and the toe of golf's shoe=28−10=18; (h). plotting a line DE to represent an eye-to-aiming device 2 line; (i). locating a point F in line AB, in which, BF=18=Club length of short-shaft driver club 1; (j). drawing the configuration of driver head 3 at point F, in which, incline angle between club shaft 5 and the top line of driver head 3 is 120 degree, top width between toe and heel of driver head 3 is 5 inches, and height between top line and sole line of driver head 3 is 2 1/2 inches; (k). finding out that line DE (i.e. eye-to-aiming device 2 line) intersects driver head 3 at toe end of driver head 3.

Again, author of present invention repeats the step (g) of graphical method of FIG. 2 by locating point E at other locations on X-axis, and finds that EG (i.e. distance between aiming device 2 and the toe line of golfer's shoes) is always equal to BF (i.e. club length of short-shaft driver club 1). As a result, author of present invention is able to develop the following practicing method for setting up short-shaft driver club 1 at 40 degree incline angle in mid air: (1). using short-shaft driver club 1 as a measuring stick to place and position aiming device 2 on ground at the club length of short-shaft driver club 1 ahead of and in parallel to the toe line of golfer's shoes; (2). positioning the front thumb of golfer's hands on grip in a substantially vertical chin-to-thumb line; and (3). aiming the toe end of driver head at aiming device 2.

Without being shown in FIG. 1 or 2, author of present invention proposes that a removable closure be provided at the butt end of grip 4, so that aiming device 2 can be inserted into the hollow space within shaft 5 for storage.

Author of present invention further proposes that, in order to enable golfer to have the same “feel” as he swings the short-shaft driver club 1 or conventional driver club, short-shaft driver club 1 shall have a Swing Weight equivalent to the Swing Weight of conventional driver club.

In the 1920s, golf club manufacturers invented Swing Weight as a measure of the dynamic “feel” of the golf club. The Swing Weight of a golf club specifies how heavy the club feels to a player swinging it. Swing Weight relates not only to the club's weight but also to the distribution of the weight. Two golf clubs may have different Spring Weight even if the total weight of club is the same. For example, a golf club with more of its mass concentrated in the club head has a heavier Swing Weight, which requires more energy for the golfer to swing it at a specific speed. A heavier Swing Weight may help golfer to slow down an overly quick swing tempo, transfer higher energy to the ball, and keep the club on track in the downswing.

It is well known in golf club industry that changing the club length has an impact to the Swing Weight of golf club. Some rules developed by golf club industry are summarized as follows: (a). reducing shaft length by ½ inch results in decreasing Swing Weight by 3 points, (b). increasing head weight by 2 grams results in increasing Swing Weight by one point, (c). increasing shaft weight by 9 grams results in increasing Swing Weight by one point, and (d). increasing grip weight by 5 gram results in decreasing Swing Weight by one point.

It is important to note that the above rules are based on an assumption that the fulcrum point of golf club is located at 14″ from the butt end of grip. It is also important to note that each rule above is independent of each other. For example, rule (a) is valid only if head weight, shaft weight and grip weight all remain constant without a change, or rule (b) is valid only if shaft length, shaft weight and grip weight all remain constant without a change.

By applying both rules (a) and (b) above, author of present invention has calculated the Compensated Weight needs to be added the driver head of short-shaft driver club 1 (say its club length=18″) in order to obtain the same Swing Weight of conventional driver club (say its club length=43″), under assumption that both clubs have an identical driver head. The result is that Compensated Weight=[(43″−18″)/½″]×3 points×2 gram/point=300 gram.

Is the above result accurate? In order to verify the above result, author of present invention develops a mechanic model (to be discussed later) to calculate the required head weight of the short-shaft driver club (club length=18″), and finds the required head weight (W) is equal to 871 gram. Therefore, Compensated Weight=W−(Head Weight of conventional driver club)=871 gram−198 gram=673 gram, which is far greater than the 300 gram calculated from rules (a) and (b). Clearly, current Swing Weight technology (including Swing Weight Chart or Swing Weight Scale) is not sufficient or adequate to solve the Swing Weight issue related to a short-shaft golf club, particularly if its shaft length is substantially reduced.

Author of present invention finds that, in a golf swing, (right-hand) golfer can better feel the Swing Weight after takeaway when golf club reaches a position in parallel to ground (and in parallel to target line). At that time, golfer's front right hand below grip acts as a support or fulcrum point, and golfer's rear left hand on top of grip forces the balance golf club. This finding helps author of present invention to develop a mechanic model that statically analyzes Swing Weight of golf club in a balanced state. Most importantly, such a mechanic model allows author of present invention to realistically set up the fulcrum point of golf club at the location of the front edge golfer's hands on grip, which is about 8 inch from the butt end of grip because golfer's hands typically occupy about 8 inch grip length from the butt end of grip. Clearly, this 8 inch fulcrum point (distanced from butt end of grip) is far less than the 14 inch fulcrum point suggested by current Swing Weight technology and widely adopted by golf club industry.

For the conventional golf (driver or iron) club:

$$X ( inch ) = Distance between the fulcrum point and the grip butt end$$

$${L}_{1} ( inch ) = Club length of conventional golf club$$

$$Head Weight 1 ( gram ) = Head weight of club head of conventional golf club$$

$$Shaft Weight 1 ( gram ) = Shaft weight of club shaft of conventional golf club$$

$$\begin{matrix}Moment 1 h ( gram \text{-} inch ) = Moment of club head weight acting on \\ fulcrum point \\ = Head Weight 1 \times ( {L}_{1} - X )\end{matrix}$$

$$Moment 1 s ( gram \text{-} inch ) = Moment of club shaft weight in front of fulcrum point acting on fulcrum point = Shaft Weight 1 \times ( {L}_{1} - X ) / {L}_{1} \times ( {L}_{1} - X ) / 2$$

$$Swing Weight 1 ( gram \text{-} inch ) = Swing Weight of conventional golf club = Moment 1 h + Moment 1 s = [ Head Weight 1 \times ( {L}_{1} - X ) ] + [ Shaft Weight 1 \times ( {L}_{1} - X ) / {L}_{1} \times ( {L}_{1} - X ) / 2 ]$$

For short-shaft golf (driver or iron) club of present invention:

$$X ( inch ) = Distance between the fulcrum point and the grip butt end$$

$${L}_{2} ( inch ) = Club length of short \text{-} shaft golf club$$

$$W ( gram ) = Head weight W of short \text{-} shaft golf club$$

$$\begin{matrix}Moment 2 h ( gram \text{-} inch ) = Moment of club head weight acting on \\ fulcrum point \\ = W \times ( {L}_{2} - X )\end{matrix}$$

By neglecting shaft weight in front of fulcrum point:

(Note: This is because: (a). shaft length in front of fulcrum point is substantially shorter than that of conventional driver club, (b). shaft weight in front of fulcrum point is negligible as compared to head weight, and (c). the center of gravity of short-shaft golf club is nearly adjacent to club head.)

$$Moment 2 s = Moment of club shaft weight in front of fulcrum point acting on fulcrum point = 0$$

$$\begin{matrix}Swing Weight 2 ( gram \text{-} inch ) = Spring Weight of short \text{-} shaft driver club \\ = Moment 2 h + Moment 2 s = W \times ( {L}_{2} - X )\end{matrix}$$

To enable golfer to have the same feel as he swings either club:

Swing Weight1 =Swing Weight 2

[Head Weight1 ×(L₁−X)]+[Shaft Weight1 ×(L₁−X)/L₁×(L₁−X)/2]=W×(L₂ −X)

W=Head weight W=[Head Weight 1+Shaft Weight 1×(L₁−X)/2L₁]×(L₁−X)/(L₂−X)

Preferably (as discussed earlier), X or the distance between the fulcrum point and the grip butt end can be represented by the distance between the front edge golfer's hands on grip and the grip butt end, which is about 8 inch because golfer's hands typically occupy about 8 inch grip length from the butt end of grip. For example, the head weight W of short-shaft driver club is calculated as 871 gram under conditions that: X=8″, L₁ (club length of conventional driver club)=43″, L₂ (club length of short-shaft driver club)=18″, Head Weight 1 (head weight of conventional driver club)=198 gram, Shaft Weight 1 (shaft weight of conventional driver club)=125 gram.

The above required head weight of short-shaft driver club can be obtained by means of constructing driver head with a high-density material heavier than that of driver head of conventional driver club, and/or filling high-density material into the hollow space within driver head. Alternatively, the above required head weight of short-shaft driver club can be obtained by: taping high density lead tapes or metal plate(s) onto driver head, fastening metal plate(s) to driver head with a mechanical fastener, or wrapping or inserting weighted element(s) around the connecting joint between driver head and shaft.

Now, the question is that can we obtain Swing Weight of short-shaft driver club equal to or greater than the Swing Weight of conventional driver club by increasing shaft weight as resulted of constructing shaft with higher density material?

Based on the mechanic model that determines Swing Weight acting on the fulcrum point located 8″ from the butt end of grip, it is clear that: (a). increasing shaft weight may increase Swing Weight of short-shaft driver club only if its club length is greater than 16″ (=8″×2), (b). increasing shaft weight has no impact to Swing Weight of short-shaft driver club if its club length is equal to 16″, and (c). increasing shaft weight may decrease Swing Weight of short-shaft driver club if its club length is shorter than 16″. After constructing shaft with higher density material, or a combined effort of constructing shaft with higher density material and increasing head weight, author of present invention believes that the total weight of short-shaft driver club can become too heavy for practicing golf swing by a regular golfer.

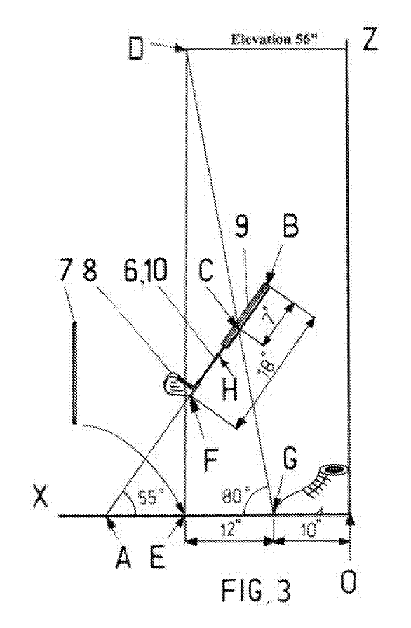

FIG. 3 shows the short-shaft iron club 6 and the aiming device 7 that form the second preferred embodiment of golf swing practicing apparatus of present invention, and the graphical method for setting up short-shaft iron club 6 at 55 degree incline angle in mid air. Short- shaft iron club 6 has an iron head 8, a grip 9, and a club shaft 10. Aiming device 7 is constructed of an elongated object, such as the short stick shown in FIG. 3. The 55 degree incline angle is based on the following input data adopted by graphical method of FIG. 3:

(1). Club length of conventional 7-Iron club commonly used in a golf game is 37 ¼″. (2). Ben Hogan has illustrated that incline angle of 7-Iron is about 55 degree at address position. (3). Ben Hogan has illustrated that, at address position, his eyes, thumb, and toe of his shoe form a sloped line at approximately 80 degree incline angle. (4). Ben Hogan's eye location is about 56″ above ground.

Graphical method of FIG. 3 consists of the following steps: (a). plotting an X-Z coordinate in scale and in a inch dimension, in which, X axis represents a horizontal ground distance pointing perpendicularly away from the front body of golfer, Z-axis represents a vertical distance above ground, and zero base O (0, 0) represents the heel of golfer's shoe when golfer is at address position; (b). plotting an 80 degree slopped line passing through the toe G of golfer's shoe on X-axis at (10, 0); (c). plotting a 55 degree sloped line AB=37 ¼ representing the conventional 7-Iron club, and locating line AB by a trial method, in which, sloped line AB is shifted back and forth horizontally until it intersects the 80 degree sloped line at point C, where BC=7; (d). locating a point D by intersecting the 80 degree slopped line and the horizontal line at elevation=56, which represents the location of golfer's eyes; (e). locating a Point E (22, 0) on X-axis to represent the location aiming device 7, in which, distance between the aiming device 7 and the toe G of golf's shoe is 12 inches (22−10=12); (f). plotting a line DE to represent an eye-to-aiming device 2 line; (g). locating a point F in line AB, in which, BF=18=Club length of short-shaft iron club 6; (h).drawing the configuration of iron head 8 at point F, where F represents the heel end of iron head 8; (i). finding out that eye-to-aiming device line DE intersects iron head 8 in the area nearby the heel end of iron head 8; (j). locating point H in mid section of shaft 10 to represent a visible marker H on shaft 10, in which, BH=12 inches.

Based on the above graphical method of FIG. 3, author of present invention is able to develop the following practicing method for setting up said short-shaft iron club 6 at 55 degree incline angle in mid air: (1). using marker H on shaft as a measuring guide to place and position aiming device 7 on ground at a predetermined distance ahead of and in parallel to the toe line of golfer's shoes, which is equal to the distance between the marker H on shaft and the butt end B of grip; (2). aiming the front thumb of golfer's hands on grip at the toe of golfer's shoe; and (3). aiming the heel end of iron head 8 at aiming device 7.

It should be noted that AB in FIG. 3 represents the club length of conventional 7-Iron commonly used in a golf game. Does this mean that short-shaft iron club 6 in FIG. 3 is only suitable for simulating the conventional 7-Iron? Can the graphical method of FIG. 3 apply to any other iron clubs besides 7-Iron? To answer this question, author of present invention repeats all the steps of graphical method of FIG. 3 by substituting AB with other club lengths of iron clubs from 2-Iron to 9-Iron, and finds the results of graphical method of FIG. 3 remain adequately valid. This means a single short-shaft iron club 6 is suitable for practicing golf swing and simulating the swing plane of all conventional iron clubs from 2-Iron and 9-Iron, provided golfer follows the above practicing method as developed by graphical method of FIG. 3. This also means that iron head 8 of short-shaft iron club 6 can be in the form of any iron head of conventional iron club between 2-Iron and 9-Iron.

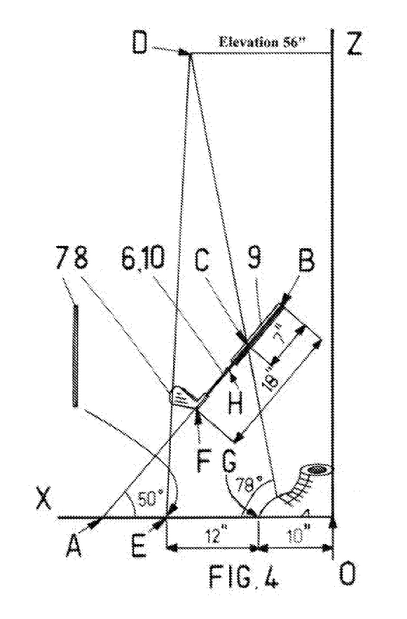

FIG. 4 shows the short-shaft iron club 6 and the aiming device 7 of FIG. 3, and the graphical method for setting up short-shaft iron club 6 at 50 degree incline angle in mid air. The 50 degree incline angle is based on the following input data adopted by graphical method of FIG. 4:

(1). Club length of 7 Iron club is 37 ¼ ″. (2). Most modern professional golfers including Tiger Wood have illustrated that incline angle of 7- Iron is about 50 degree at address position. (3). Tiger Wood has illustrated that, at address position, his eye, thumb, and the front cup head of his shoe form a sloped line at approximately 78 degree incline angle. (4). Wood's eye location is about 56″ above ground at address position.

Graphical method of FIG. 4 basically repeats all the steps of graphical method of FIG. 3 as discussed earlier. As a result, author of present invention is able to develop the following practicing method for setting up short-shaft iron club 6 at 50 degree incline angle in mid air: (1). using marker H on shaft as a measuring guide to place and position aiming device 7 on ground at a predetermined distance ahead of and in parallel to the toe line of golfer's shoes, which is equal to the distance between the marker H on shaft and the butt end of grip; (2). aiming the front thumb of golfer's hands on grip at the toe cup of golfer's shoe; and (3). aiming the toe end of iron head at aiming device 7.

It should be noted that the above (2) step in practicing method can be modified as “aiming the front thumb of golfer's hands on grip at the toe of golfer's shoe.” This is because toe cup of golfer's shoe is closely adjacent to toe of golfer's shoe, and the toe of golfer's shoe can be easier identified by golfer easier.

In FIG. 4, club length (BF) of short-shaft iron club 6 is equal to 18 inch, distance (EG) between aiming device 7 and toe line of golfer's shoes is equal to 12 inch, and distance (BH) between marker H and grip's butt end B is equal to 12 inch. Again (as discussed earlier), a single short-shaft iron club 6 is suitable for practicing golf swing and simulating the swing plane of any iron club from 2-Iron to 9-Iron, provided golfer follows the above practicing method as developed by graphical method of FIG. 4.

Without being shown in FIG. 3 or 4, author of present invention proposes that a removable closure be provided at the butt end of grip 9, so that aiming device 7 can be inserted into the hollow space within shaft 10 for storage.

In order to enable golfer to have the same “feel” as he swings short-shaft iron club 6 or any particular conventional iron club between 2-Iron and 9-Iron, short-shaft iron club 6 shall have a Swing Weight equivalent to the Swing Weight of that particular conventional iron club. According to the mechanic model and analyses as discussed earlier, the above objective can be achieved if iron head 8 has a head weight equal to or greater than the head weight W determined as follows:

Head weight W=[Head Weight 1+Shaft Weight 1×(L₁−X)/2 L₁]×(L₁−X)/(L₂×X)

Wherein: head weight W is in gram, Head Weight 1 (in gram) represents the head weight of that particular conventional iron club between 2-Iron and 9-Iron, Shaft Weight 1 (in gram) represents the shaft weight of that particular conventional iron club between 2-Iron and 9-Iron, L₁ (in inch) represents the club length of that particular conventional iron club, L₂ (in inch) represents the club length of short-shaft driver club, and X (in inch) represents the distance between the fulcrum point and the grip butt end of short-shaft iron club. Preferably (as discussed earlier), X (in inch) can be represented by the distance between the front edge of golfer's hands on grip and the grip butt end, which is about 8 inch because golfer's hands typically occupy about 8 inch grip length from the butt end of grip. For example, the head weight W of a short-shaft iron club is calculated as 914 gram under conditions that: short-shaft iron club is used for simulating golf swing of conventional 7-Iron club, X=8″, L₁=36.5″, L₂=18″, Head Weight 1=272 gram, and Shaft Weight 1=125 gram.

The required head weight of short-shaft iron club can be obtained by means of constructing the iron head with a high-density material heavier than the material of iron head of conventional iron club, or constructing the iron head with a body volume greater than that of iron head of conventional iron club. Alternatively, the above required head weight of short-shaft iron club can be obtained by means of: taping high density lead tapes or metal plate(s) onto iron head, fastening metal plate(s) to iron head with a mechanical fastener, or wrapping or inserting weighted element(s) around the connecting joint between iron head and shaft.

What is claimed is:

1. A golf swing practicing apparatus and practicing methods, wherein:
said golf swing practicing apparatus comprises of a short-shaft driver club and an aiming device, and said practicing methods teach golfer how to set up said short-shaft driver club at a proper incline angle between 40 and 45 degrees in mid air at address position before initiating golf swing, and thus enable golfer to practice golf swing in a proper swing plane corresponding to said incline angle;
said short-shaft driver club has a shaft inserted between a driver head and a grip, and said driver head or grip is in the form identical to that of the driver head or grip of a conventional driver club commonly used in a golf game;
said short-shaft driver club has a club length represented by a longitudinal distance between the butt end of said grip and the heel end of said driver head, and said club length is substantially reduced to enable golfer to practice golf swing in a confined environment with said driver head being suspended in mid air at address position;
said aiming device is constructed of an elongated object such as a short stick, said aiming device is placed on ground at a predetermined distance ahead of and in parallel to the toe line of golfer's shoes, and said aiming device is used to assist golfer to set up said short-shaft driver club at said incline angle in mid air by aiming said driver head at said aiming device;
said butt end of said grip is provided with a removable closure so that said aiming device can be inserted into the hollow space within said shaft for storage;
said club length of said short-shaft driver club is equal to said predetermined distance between said aiming device and said toe line of golfer's shoes;
a first practicing method consists of the following steps for setting up said short-shaft driver club at 45 degree incline angle in mid air at address position: (1). using said short-shaft driver club as a measuring stick to place and position said aiming device on ground at said club length of said short-shaft driver club ahead of and in parallel to said toe line of golfer's shoes; (2). positioning the front thumb of golfer's hands on said grip in a substantially vertical eye-to-thumb line; and (3). aiming said heel end of said driver head at said aiming device; and
a second practicing method consists of the following steps for setting up said short-shaft driver club at 40 degree incline angle in mid air at address position: (1). using said short-shaft driver club as a measuring stick to place and position said aiming device on ground at said club length of said short-shaft driver club ahead of and in parallel to said toe line of golfer's shoes; (2). positioning the front thumb of golfer's hands on said grip in a substantially vertical chin-to-thumb line; and (3). aiming the toe end of said driver head at said aiming device.

2. The golf swing practicing apparatus and practicing methods according to claim 1, in which, said short-shaft driver club has a Swing Weight equal to or greater than the Swing Weight of said conventional driver club commonly used in a golf game;
said short-shaft driver club or said conventional driver club has a fulcrum point located at the same distance from said butt end of said grip; and
said driver head of said short-shaft driver club has a head weight equal to or greater than the head weight W determined as follows:
said head weight W=[Head Weight 1+Shaft Weight 1×(L₁−X)/2 L₁]×(L₁−X)/(L₂−X) wherein: said head weight W is in gram, said Head Weight 1 in gram represents the head weight of said conventional driver club, said Shaft Weight 1 in gram represents the shaft weight of said conventional driver club, said L₁ in inch represents the club length of said conventional driver club, said L₂ in inch represents said club length of said short-shaft driver club, and said X in inch represents said distance from said fulcrum point to said grip butt end of said short-shaft driver club.

3. The short-shaft driver club according to claim 2, in which, said X or said distance from said fulcrum point to said grip butt end is equal to the distance from the front edge of golfer's hands on said grip to said grip butt end, which is about 8 inch.

4. The short-shaft driver club according to claim 2, in which, said short-shaft driver club obtains said head weight W by means of constructing said driver head with a high-density material heavier than the material of said driver head of said conventional driver club.

5. The short-shaft driver club according to claim 2, in which, said short-shaft driver club obtains said head weight W by means of filling high-density material into the hollow space within said driver head.

6. The short-shaft driver club according to claim 2, in which, said short-shaft driver club obtains said head weight W by means of taping high density lead tapes or metal plate(s) onto said driver head, fastening said metal plate(s) to said driver head with a mechanical fastener, or wrapping or inserting weighted element(s) around the connecting joint between said driver head and said shaft.

7. The golf swing practicing apparatus and practicing methods according to claims 1-3, in which, said club length of said short-shaft driver club is equal to 18 inch, said predetermined distance between said aiming device and said toe line of golfer's shoes is equal to 18 inch, and said head weight W is equal to 871 gram under conditions that said X=8″, said L₁=43″, said L₂=18″, said Head Weight 1=198 gram, and said Shaft Weight 1=125 gram.

8. A golf swing practicing apparatus and practicing method, wherein:
said golf swing practicing apparatus comprises of a short-shaft iron club and an aiming device, and said practicing method teaches golfer how to set up said short-shaft iron club at a proper incline angle between 50 and 55 degrees in mid air at address position before initiating golf swing, and thus enable golfer to practice golf swing in a proper swing plane corresponding to said incline angle;
said short-shaft iron club has a shaft inserted between an iron head and a grip, and said iron head or grip is in the form identical to that of the iron head or grip of a conventional iron club commonly used in a golf game;
said short-shaft iron club has a club length represented by a longitudinal distance between the butt end of said grip and the heel end of said iron head, and said club length is substantially reduced to enable golfer to practice golf swing in a confined environment with said iron head being suspended in mid air at address position;
said aiming device is constructed of an elongated object such as a short stick, said aiming device is placed on ground at a predetermined ground distance ahead of and in parallel to the toe line of golfer's shoes, and said aiming device is used to assist golfer to set up said short-shaft iron club at said incline angle in mid air by aiming said iron head at said aiming device;
said butt end of said grip is provided with a removable closure so that said aiming device can be inserted into the hollow space within said shaft for storage;
said shaft has a visible marker, and the distance from said marker to said grip's butt end is equal to said predetermined ground distance between said aiming device and said toe line of golfer's shoes; and
said practicing method consists of the following steps: (1). using said marker on said shaft as a measuring guide to place and position said aiming device on ground at said predetermined ground distance ahead of and in parallel to said toe line of golfer's shoes; (2). aiming the front thumb of golfer's hands on said grip at the toe of golfer's shoe; and (3). aiming said iron head at said aiming device.

9. The golf swing practicing apparatus and practicing method according to claim 8, in which, said practicing method teaches golfer to set up said short-shaft iron club at 55 degree incline angle in mid air at address position, and said step (3) of said practicing method is by means of aiming said heel end of said iron head at said aiming device.

10. The golf swing practicing apparatus and practicing method according to claim 8, in which, said practicing method teaches golfer to set up said short-shaft iron club at 50 degree incline angle in mid air at address position, and said step (3) of said practicing method is by means of aiming the toe end of said iron head at said aiming device.

11. The golf swing practicing apparatus and practicing method according to claim 8, in which, said iron head of said short-shaft iron club is in the form of the iron head of a particular conventional iron club between 1-Iron and 9-Iron, and said short-shaft iron club has a Swing Weight equal to or greater than the Swing Weight of said particular conventional iron club;
said short-shaft iron club or said conventional iron club has a fulcrum point located at the same distance from said butt end of said grip; and
said iron head of said short-shaft iron club has a head weight equal to or greater than the head weight W determined as follows:
said head weight W=[Head Weight 1+Shaft Weight 1×(L₁−X)/2L₁]×(L₁−X)/(L₂−X)
wherein: said head weight W is in gram, said Head Weight 1 in gram represents the head weight of said particular conventional iron club, said Shaft Weight 1 in gram represents the shaft weight of said particular conventional iron club, said L₁ in inch represents the club length of said particular conventional iron club, said L₂ in inch represents said club length of said short-shaft iron club, and said X in inch represents said distance from said fulcrum point to said grip butt end of said short-shaft iron club.

12. The short-shaft iron club according to claim 11, in which, said X or said distance from said fulcrum point to said grip butt end is equal to the distance from the front edge of golfer's hands on said grip to said grip butt end, which is about 8 inch.

13. The short-shaft iron club according to claim 11, in which, said short-shaft iron club obtains said head weight W by means of constructing said iron head with a high-density material heavier than the material of said iron head of said conventional iron club.

14. The short-shaft iron club according to claim 11, in which, said short-shaft iron club obtains said head weight W by means of constructing said iron head with a body volume greater than that of said iron head of said conventional iron club.

15. The short-shaft iron club according to claim 11, in which, said short-shaft iron club obtains said head weight W by means of taping high density lead tapes or metal plate(s) onto said iron head, fastening said metal plate(s) to said iron head with a mechanical fastener, or wrapping or inserting weighted element(s) around the connecting joint between said iron head and said shaft.

16. The golf swing practicing apparatus and practicing method according to claims 8, 11 and 12, in which, said club length of said short-shaft iron club is equal to 18 inch, said predetermined distance between said aiming device and said toe line of golfer's shoes is equal to 12 inch, said distance between said marker and said grip's butt end is equal to 12 inch, and said head weight W is equal to 914 gram under conditions that said short-shaft iron club is used for simulating golf swing of conventional 7-Iron club, said X=8″, said L₁=club length of said conventional 7-Iron club=36.5″, said L₂=18″, said Head Weight 1=head weight of said conventional 7-Iron club=272 gram, and said Shaft Weight 1=shaft weight of said conventional 7-Iron club=125 gram.
